(19) United States
(12) Patent Application Publication
(10) Pub. No.: US 2009/0270058 A1
(43) Pub. Date: Oct. 29, 2009

(54) SYSTEMS AND METHODS FOR ADJUSTMENT OF A FREQUENCY MODULATION RADIO FREQUENCY

(75) Inventor: CHUN-WEI CHENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/206,737

(22) Filed: Sep. 9, 2008

(30) Foreign Application Priority Data
Apr. 24, 2008 (CN) 200810301275.3

(51) Int. Cl. H04B 1/18; G01S 5/14

(52) U.S. Cl. 455/179.1; 342/357.13

(57) ABSTRACT

A system for adjusting a frequency modulation (FM) radio frequency is provided. The system includes determining a preferred frequency of a region and converting a current frequency of the FM radio to the preferred frequency if the current frequency is different from the preferred frequency. A related method is also provided.

### BACKGROUND

1. Field of the Invention

Embodiments of the present disclosure are related to a frequency modulation radio frequency, and particularly to a system and method for adjusting a frequency modulation radio frequency utilizing Global Positioning System (GPS) information.

2. Description of Related Art

Frequency modulation (FM) radios have been well-known since its disclosure by Edwin Armstrong in 1936. An FM radio is a commonly used device. The FM radio has a FM receiver for reception of FM radio signals broadcasted from FM broadcast sources in a local region.

In FM radio technology, the FM receiver employs a tuner to receive a stronger of one or more stations being broadcast on a same FM frequency. Therefore, signal interference rarely occurs during use of an FM radio in a fixed position or region.

However, a single FM broadcast source may use different frequencies for broadcast in different regions due to broadcast power limitations or spectrum allocation restrictions. Accordingly, the FM frequency strength can suffer when receiver position changes, such as in a vehicle traveling a long distance away from the broadcast source. Sometimes, a signal from another FM broadcast source B may even be audible over the weakening original signal when approaching the broadcast source of Signal B. This causes great inconvenience to the user, requiring frequent adjustment of the FM radio.

### SUMMARY

A method for adjusting a frequency modulation (FM) radio frequency is provided. The method includes storing preferred frequencies of different FM broadcast sources of different regions into a frequency database system, receiving a radio signal of a current broadcast source and obtaining a current frequency thereof through a frequency modulation receiver, obtaining a current position of the receiving frequency modulation radio through a GPS and determining a region thereof, retrieving a preferred frequency of the current regional broadcast source from a frequency database system, comparing the current frequency to the preferred frequency, and tuning the current frequency to the preferred frequency if they are not equal.

Other objects, advantages and novel features will become more apparent from the following detailed description of certain embodiments of the present disclosure when taken in conjunction with the accompanying drawings, in which:

### BRIEF DESCRIPTION OF THE DRAWINGS

FIG. 1 is a block diagram of one embodiment of an FM radio system comprising an adjustment system for adjusting a frequency modulation (FM) radio frequency.

FIG. 2 is a table illustrating an example of preferred radio frequencies corresponding to 3 different FM broadcast sources in 3 regions.

FIG. 3 is a flowchart of one embodiment of a method for adjusting a frequency modulation radio frequency of the FM radio of the present disclosure.

### DETAILED DESCRIPTION OF CERTAIN INVENTIVE EMBODIMENTS

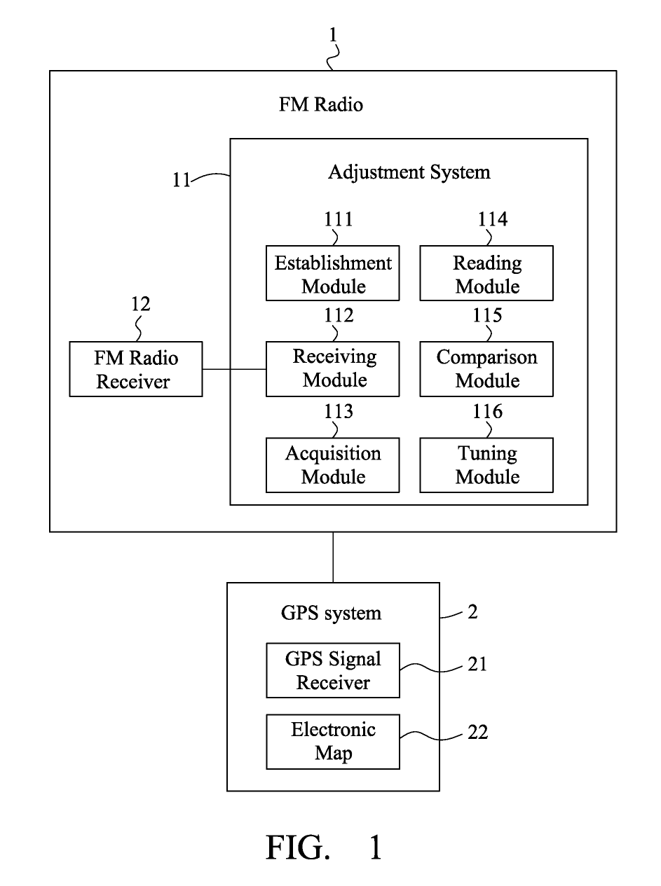

FIG. 1 is a block diagram of one embodiment of an FM radio system 1 comprising an adjustment system 11 for adjusting a frequency modulation (FM) radio frequency. The FM radio 1 further includes an FM radio receiver 12 for receiving radio signals broadcasted by FM broadcast sources. In an exemplary embodiment, the FM radio 1 may be a built-in radio in a vehicle, while in other embodiments, the FM radio 1 can be any electronic device for receiving and playing content broadcasted by FM broadcast sources.

The FM radio 1 is connected to a GPS system 2 for obtaining a current position of the FM radio 1. The GPS system 2 includes a GPS signal receiver 21 and an electronic map 22. The GPS system 2 is configured for collecting GPS signals from one or more satellites and determining a current position of the FM radio 1. The GPS system 2 is further configured for determining a precise position of the FM radio 1 based on the electronic map 22.

In one embodiment, the adjustment system 11 includes an establishment module 111, a receiving module 112, an acquisition module 113, a reading module 114, a comparison module 115, and a tuning module 116. The modules 111, 112, 113, 114, 115, 116 may be used to execute one or more operations for the FM radio 1. Additionally, the FM radio 1 may comprise one or more specialized or general purpose processors for executing the modules 111, 112, 113, 114, 115, 116.

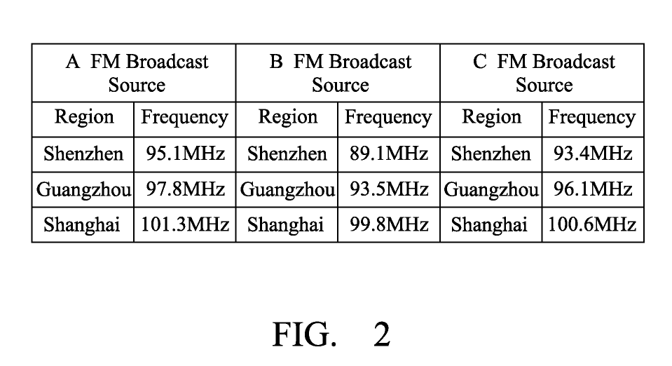

The establishing module 111 is configured for storing one or more preferred frequencies of different FM broadcast sources of different regions into a frequency database system. The frequency database system comprises a database of preferred FM frequencies of one or more FM broadcast stations in a selective region. An example of preferred frequencies for three FM broadcast sources in three different regions is illustrated in FIG. 2. Frequencies of an FM broadcast source A are 95.1 MHz in Shenzhen, 97.8 MHz in Guangzhou, and 101.3 MHz in Shanghai. Frequencies of an FM broadcast source B are 89.1 MHz in Shenzhen, 93.5 MHz in Guangzhou, and 99.8 MHz in Shanghai. Additionally, frequencies of an FM broadcast source C are 93.4 MHz in Shenzhen, 96.1 MHz in Guangzhou, and 100.6 MHz in Shanghai. It may be understood that the establishing module 111 may update the frequency database system so as to add/edit/delete selective FM broadcasts sources and/or FM frequencies.

The receiving module 112 is configured for receiving radio signals of a current FM broadcast source through the FM radio receiver 12 of the FM radio 1, and determining a current frequency of the current FM broadcast source. For example, if the FM radio 1 is located in a region of Shenzhen and tuned to the FM broadcast source A, a current frequency of the current FM broadcast source A is 95.1 MHz.

The acquisition module 113 is configured for acquiring a current position of the FM radio 1 through the GPS system 2, and determining a region of the current position based on information from the electronic map 22. In this example, if the current position of the FM radio 1 changes to somewhere closer to Guangzhou along a freeway connecting Shenzhen and Guangzhou, the acquisition module 113 consequently determines the current position of the FM radio 1 to be in a region of Guangzhou.

The reading module 114 is configured for acquiring a preferred frequency of the FM broadcast source in the confirmed region from the frequency database system based on the current position acquired by the acquisition module 113. In this example, the reading module 114 acquires a preferred frequency of the FM broadcast source A of 97.8 MHz, if the FM radio 1 is in the region of Guangzhou.

The comparison module 115 is configured for comparing the current frequency acquired by the receiving module 112 to the preferred frequency acquired by the reading module 114.

The tuning module 116 is configured for tuning the current frequency to the preferred frequency if the current frequency differs from the preferred frequency. Tuning the current frequency to the preferred frequency ensures stable and continual reception of the radio signals from a specified FM broadcast source by the FM radio 1. In this example, if the comparison module 115 acquires a preferred frequency for the FM broadcast source A of 97.8 MHz, different from the current frequency of 95.1 MHz acquired by the receiving module 112, then the tuning module 116 tunes the current frequency of the FM radio 1 to 97.8 MHz.

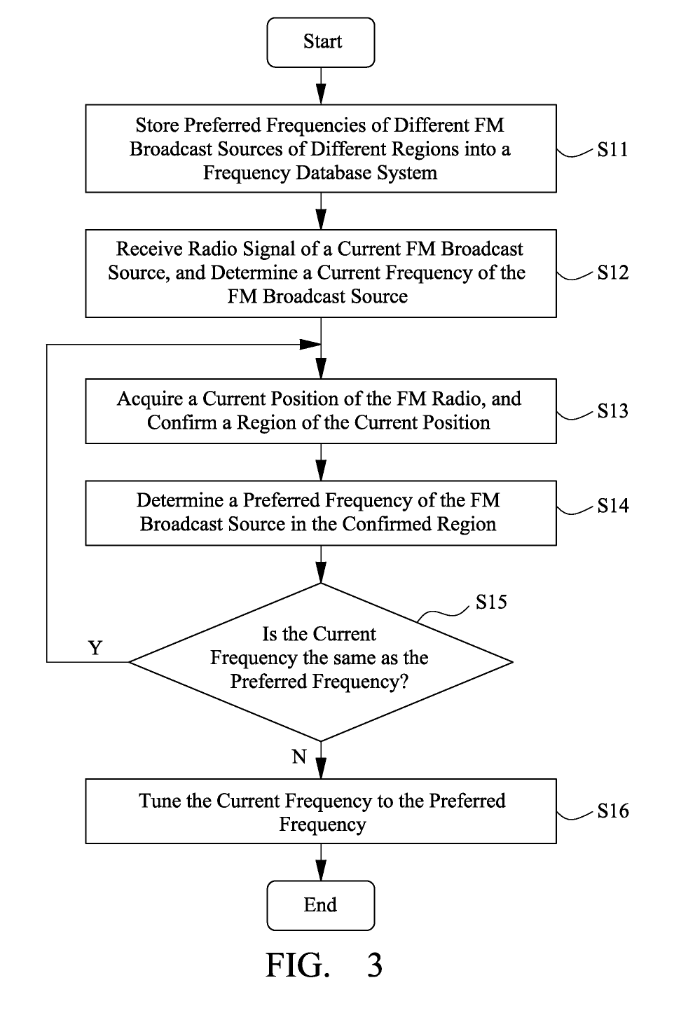

FIG. 3 is a flowchart of one embodiment of a method for adjusting an FM radio frequency of the FM radio 1 of the present disclosure. Depending on the embodiment, additional blocks may be added or deleted and the blocks may be executed in a different order than described. First, in block S11, the establishment module 111 stores one or more preferred frequencies of different FM broadcast sources of different regions into a frequency database system.

In block S12, the receiving module 112 receives radio signals of a current broadcast source through the FM radio receiver 12 of the FM radio 1, and determines a current frequency of the current FM broadcast source.

In block S13, the acquisition module 113 acquires a current position of the FM radio 1 through the GPS system 2, and determines a region of the current position based on information from the electronic map 22.

In block S14, the reading module 114 acquires a preferred frequency of the current FM broadcast source from the confirmed region from the frequency database system.

In block S15, the comparison module 115 determines if the current frequency acquired by the receiving module 112 is substantially the same as the preferred frequency acquired by the reading module 114.

In block S16, the tuning module 116 tunes the current frequency to the preferred frequency if the current frequency differs from the preferred frequency. As mentioned above, tuning the current frequency to the preferred frequency ensures stable and continual reception of the radio signal from a specified FM broadcast source by the FM radio 1.

In block S15, if the current frequency is substantially the same as the preferred frequency, the procedure returns to the block S13.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for adjusting a frequency modulation (FM) radio frequency of an FM radio, the system comprising:
an establishment module configured for storing one or more preferred frequencies of different FM broadcast sources of different regions into a frequency database system;
a receiving module configured for receiving a radio signal of a current frequency modulation broadcast source through a frequency modulation receiver of the FM radio, and determining a current frequency of the current frequency modulation broadcast source;
an acquisition module configured for acquiring a current position of the frequency modulation radio through a Global Positioning System (GPS), and determining a region of the FM radio;
a reading module configured for acquiring a preferred frequency of a current frequency modulation broadcast source in the region determined from the frequency database system;
a comparison module configured for determining if the current frequency is substantially the same as the preferred frequency; and
a tuning module configured for tuning the current frequency to the preferred frequency if the current frequency is not substantially the same as the preferred frequency.

2. The system as claimed in claim 1, wherein the GPS system comprises a GPS signal receiver and an electronic map.

3. The system as claimed in claim 2, wherein the GPS system collects GPS coordinates through the GPS signal receiver, and identifies the current position on the electronic map.

4. The system as claimed in claim 1, wherein the FM radio is a built-in radio in a vehicle.

5. A computer-implemented method for adjusting a frequency modulation (FM) radio frequency for an FM radio, the method comprising:
storing one or more preferred frequencies of different FM broadcast sources of different regions into a frequency database system;
receiving a radio signal of a current frequency modulation broadcast source through a frequency modulation receiver of the FM radio, and determining a current frequency of the current frequency modulation broadcast source;
acquiring a current position of the FM radio through a GPS system, and determining a region of the frequency modulation radio;
acquiring a preferred frequency for the current frequency modulation broadcast source in the region determined from the frequency database system;
determining if the current frequency is substantially the same as the preferred frequency; and
tuning the current frequency to the preferred frequency if the current frequency is not substantially the same as the preferred frequency.

6. The method as claimed in claim 5, further comprising:
returning to the position acquisition block if the current frequency is substantially the same as the preferred frequency.

7. The method as claimed in claim 5, wherein the GPS system comprises a GPS signal receiver and an electronic map.

8. The method as claimed in claim 7, wherein the GPS system collects GPS coordinates through the GPS signal receiver, and identifies the current position of the frequency modulation radio on the electronic map.

9. The method as claimed in claim 5, wherein the frequency modulation radio is a built-in radio in a vehicle.
